(19) United States
(12) Patent Application Publication
(10) Pub. No.: US 2012/0297282 A1
(43) Pub. Date: Nov. 22, 2012

(54) Assessment document generation system and method

(76) Inventor: Colin Shanafelt, Austin, TX (US)

(21) Appl. No.: 13/068,561

(22) Filed: May 16, 2011

(51) Int. Cl. G06F 17/00; G06F 17/24

(52) U.S. Cl. 715/220; 715/273; 715/256

(57) ABSTRACT

The present invention is an assessment document generation method and system whereby users generate assessment feedback documents by selecting appropriate indicator fields. Each indicator field and its accompanying indicator field label correspond to blocks of pre-written and fully editable text. After users move through the tabbed interface and select appropriate indicator fields, the software compiles the corresponding pre-written blocks of text into a final assessment document that can be stored, viewed, printed, transmitted electronically, and/or exported to a computer readable storage medium from within the software interface. The software is an assessment tool whereby users can quickly evaluate the work, products, and/or performances of others by selecting indicator fields to create a detailed, targeted, and comprehensive assessment feedback document.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### COMPUTER PROGRAM LISTING COMPACT DISK APPENDIX

Computer Program Listing Appendix
1. A total of 2 compact disks are attached to this application.
2. Copy 1
   a. The attached CD ROM contains source code for the Assessment Document Generation System and Method that is the subject of this patent application.
   b. The compact disk contains a file named EssayGrader.PDF, created on May 13, 2011.
   c. File Type: PDF
   d. File Size: 1.7 MB
   e. EssayGrader.PDF is a source code printout; the code itself was written in Cocoa (Apple's Objective-C based programming environment for Mac OS X) with the Apple Macintosh program Xcode for the Apple Macintosh machine format with an operating system compatibility of Apple Macintosh OS 10.6 and higher.
3. Copy 2—The two compact disks are identical.

### BACKGROUND OF THE INVENTION

The present invention is in the technical field of Data Processing.

More specifically, the present invention is in the technical field of data processing: presentation processing of document, operator interface processing, and screen saver display processing.

Even more specifically, the present invention is in the technical field of computer-assisted Assessment Document Generation.

Traditionally, those who assess the work or performance of others have had to type or hand-write assessment feedback notes, comments, and documents. This labor-intensive activity often involved re-writing the same comments over and over again. This fact has led to the need for a method and system of generating assessment documents faster, better, with less labor, and with less duplication of effort.

### SUMMARY OF THE INVENTION

The present invention is a method and computer program product system whereby pre-written blocks of text are compiled into one cohesive assessment document. Users select various indicator fields and the software compiles corresponding pre-written blocks of text into a final document. The software functions as an assessment tool whereby users can quickly evaluate the work, products, and/or performance of others by selecting indicator fields to create a detailed, targeted, and comprehensive assessment feedback document that can be saved on a computer storage medium, printed, and/or electronically transmitted.

### BRIEF DESCRIPTION OF THE DRAWINGS

FIG. 1 is a screen shot of the computer interface on the “Content” tab of the present invention;

FIG. 2 is a screen shot of the computer interface on the “Grade” tab of the present invention;

FIG. 3 is a screen shot of the computer interface on the “Opening Free Write” tab of the present invention;

FIG. 4 is a screen shot of the computer interface on the “List Screen” tab of the present invention; and

FIG. 5 is a screen shot of an example feedback assessment document generated by the present invention.

### DETAILED DESCRIPTION OF THE INVENTION

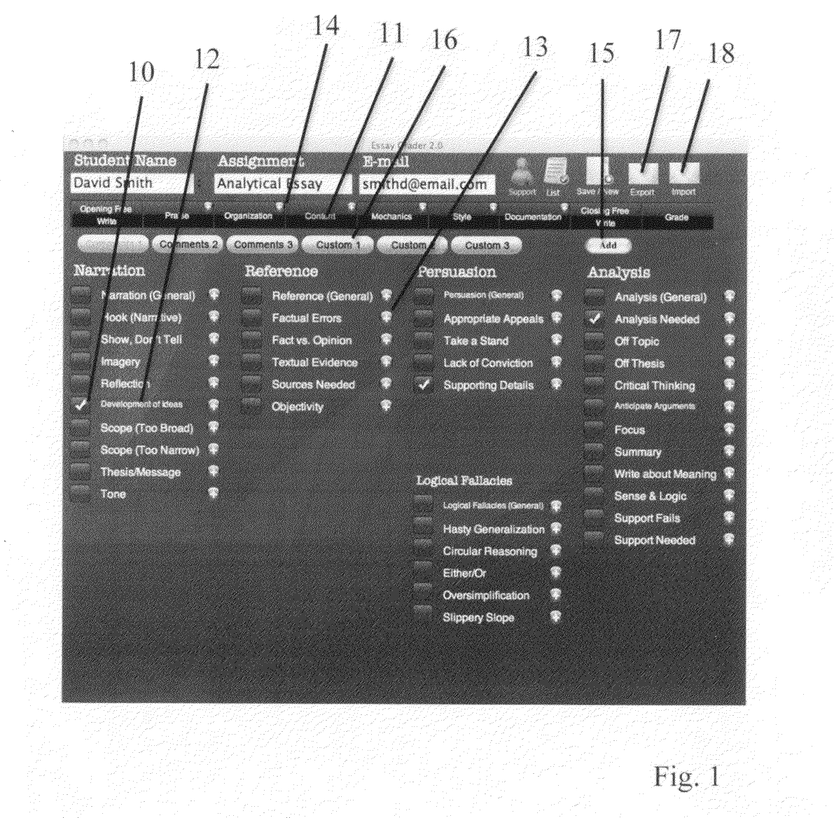

Referring now to the invention in more detail, in FIG. 1 users select the indicator fields 10 for various pre-written blocks of text in order to compile those pre-written blocks of text into a final document. In future versions of the invention the “indicator fields” may take the form of buttons, icons, check boxes, fill areas, links, symbols, words, phrases, and/or other shapes with or without accompanying indicator field labels. Users move back and forth between the tabs 11 at the top of the computer interface window and select indicator fields to easily compile (generate or write) a text document. The text document created is a compilation of pre-written blocks of text that correspond to the indicator fields and indicator field labels 12 chosen by the user. The software can function as an assessment tool whereby users can quickly evaluate the work, products, and/or performance of others by selecting indicator fields to create a detailed, targeted, and comprehensive assessment feedback document.

Also referring to FIG. 1, all indicator field labels and the blocks of pre-written text to which they refer are editable by pressing the red symbol 13 to the right of the indicator field label. In this way, the software is fully customizable and can be configured by users to create documents for any purpose. Tab labels are also editable by pressing the red symbol 14 in their upper right corners. Finally, entirely new indicator fields, indicator field labels, and corresponding blocks of text can be created by pressing the “Add” button 15 in the upper right corner of the computer interface window.

Still referring to FIG. 1, the software can store and utilize a plurality of unique versions of each specific pre-written block of text. The row of buttons 16 along the top, “Comments 1,” “Comments 2,” etc. are used to switch between the plurality of unique versions of each pre-written block of text. In addition, by pressing the “Export” button 17 in the upper right-hand corner of the interface window, users can choose to export the list of final assessment documents they have created to a folder on their computer's storage medium OR export a spreadsheet database containing all indicator field labels and the plurality of unique varieties of pre-written blocks of text to which they correspond to a computer readable storage medium where the said spreadsheet database may be edited using third-party software programs and then imported back into the present invention to be used to compile assessment documents. Finally, by pressing the “Import” button 18 the said spreadsheet database can be imported back into the program for use.

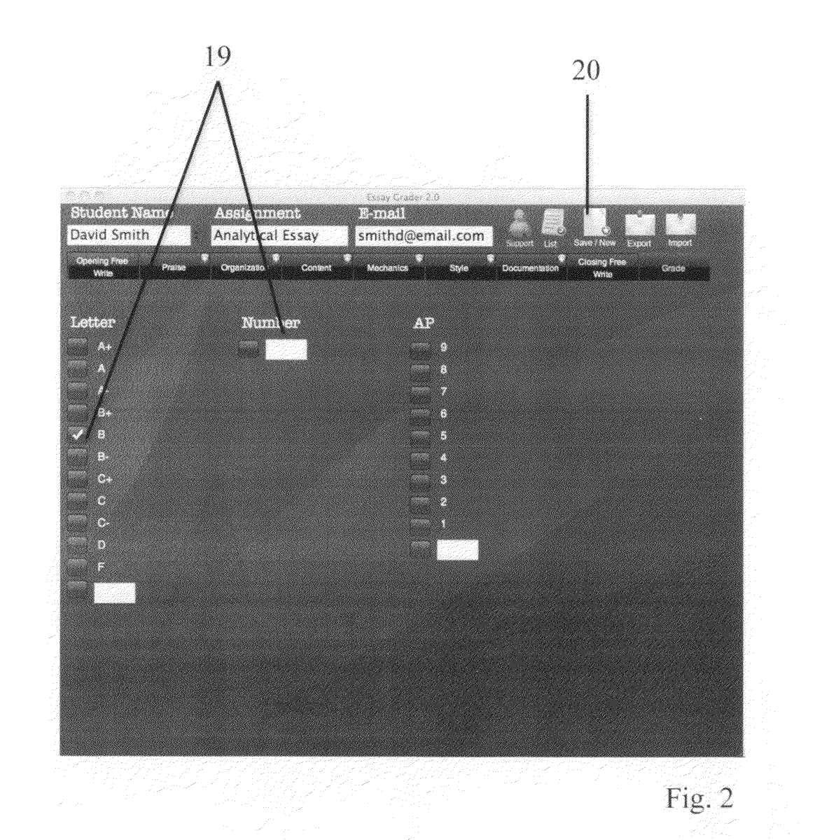

Now referring to FIG. 2, by selecting on the field indicator for the desired letter grade or by specifying a number grade 19, users can assess the work and performance of others. The letter or number grade chosen by the user is added to the bottom of the final assessment document. Also, when users finish creating one assessment feedback document, they can save that document and move on to a new document by pressing the “Save/New” button 20. When the “Save/New” button is pressed, the software compiles all user-selected blocks of text into one cohesive text document and saves that document for further use.

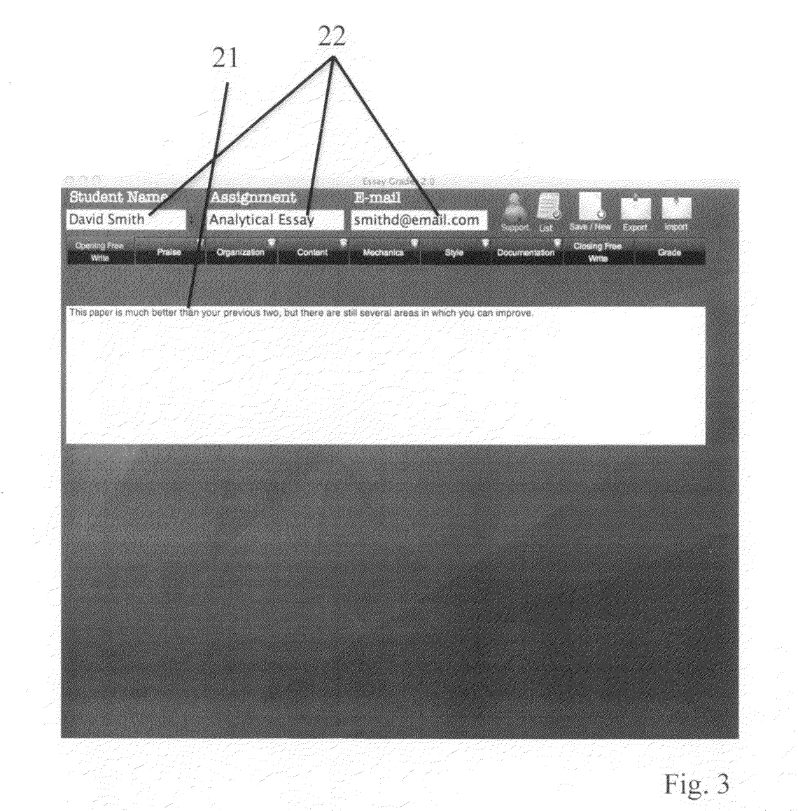

As illustrated in FIG. 3, on the “Opening Free Write” screen, users can manually type any text they wish 21 and that text will become the first paragraph of the assessment feedback document. On the “Closing Free Write” screen, the typed text will become the last paragraph of the assessment feedback document.

Also in FIG. 3, notice the “Student Name,” “Assignment,” and “Email” fields. Data can be imported into these fields from a simple .csv spreadsheet database file by pressing the “Import” button. This allows users to easily import names, evaluation subject titles, and email addresses thus eliminating the need to type this information into the interface upon the creation of every file.

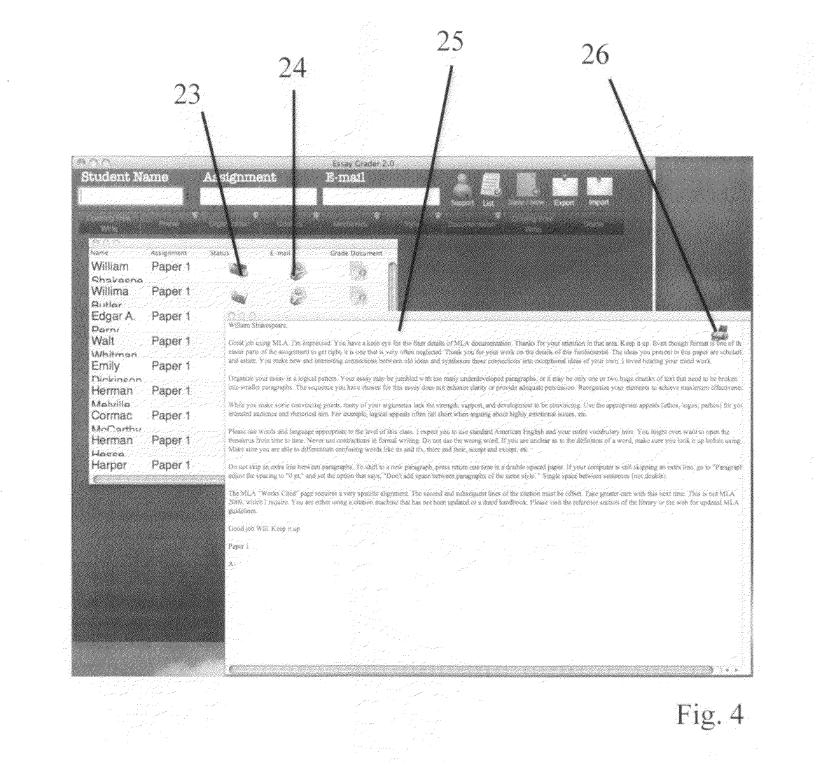

Moving to FIG. 4, from the “List” screen users can:
1. Return to previously saved files for further editing and development 23
2. Electronically transmit text documents to appropriate recipients 24
3. View/read the created documents 25
4. Print created documents 26

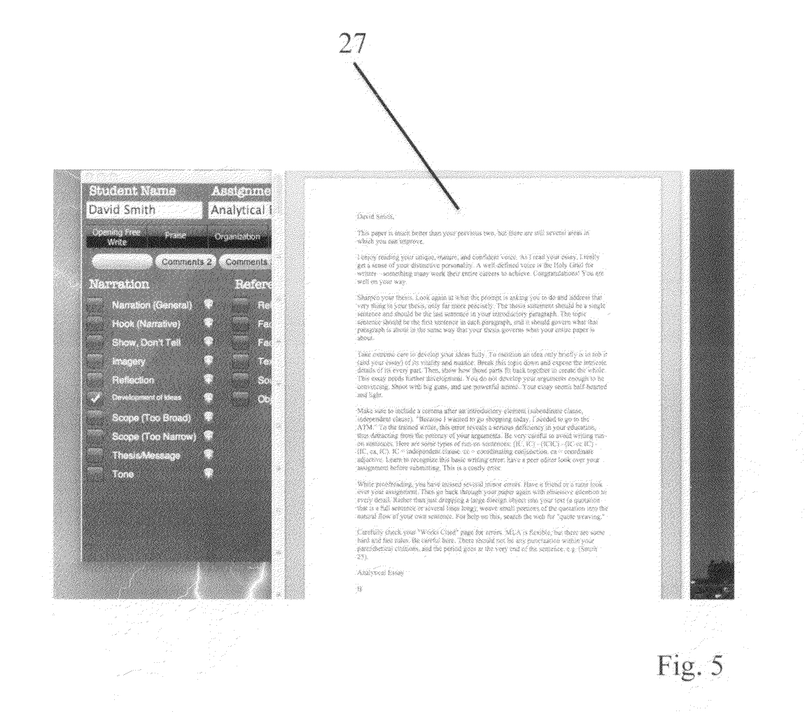

Finally, FIG. 5 shows an example of a final assessment document 27 generated by the present invention. The “Student Name” field becomes the salutation (and file name), and each tab on the computer interface corresponds to a separate paragraph in the final document. The assignment name and grade are positioned at the bottom of the assessment document.

The source code for the present invention can be located and viewed on either of the two identical CD ROMs attached to this application as described in the Computer Program Listing Appendix above.

The advantages of the present invention include but are not limited to the following:
1. The ability to create long, coherent, and meaningful documents with minimal effort.
2. The ability to quickly assess the work and/or performance of others and provide extensive feedback without having to type or hand-write the same text over and over again.
3. The ability to assess large numbers of students, employees, performers, products, etc. very quickly and in real-time (as with grading speeches, debates, or sporting events).
4. The ability to assess the work of others in environments where typing or writing by hand would not be possible or practical.
5. The ability to greatly reduce the workload of teachers, professors, employers, judges, and the like.
6. The ability to customize the software to conform to just about any discipline or need.

In broad embodiment, the present invention is an assessment document generation method and software product system whereby users can evaluate the work and performances of others by selecting indicator fields on a computer program interface to generate, save, print, and electronically transmit assessment documents.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention claimed is:

1. A computer-implemented method of generating an assessment feedback document by compiling pre-written blocks of text into one cohesive document according to the user selection of indicator fields on computer program interface that correspond to the aforementioned pre-written blocks of text and that may or may not be accompanied by indicator field labels.

2. A method of claim 1 whereby users can grade, assess, and evaluate the work and performance of others by inserting a letter grade, number grade, or numerical value into said document according to the user selection of the indicator field that corresponds to the desired grade or value or by typing a user-defined grade or value into a text box and selecting the indicator field for that box.

3. A method of claim 1 whereby each indicator field and its accompanying indicator field label can correspond to a plurality of unique varieties of pre-written blocks of text.

4. A method of claim 1 whereby said document can be printed and/or electronically transmitted to appropriate parties.

5. A method of claim 1 whereby said document can be stored on or in a computer readable storage medium.

6. A method of claim 1 whereby users can edit indicator field labels and their corresponding blocks of pre-written text from within the computer program interface.

7. A method of claim 1 whereby entirely new indicator fields, indicator field labels, and their corresponding blocks of pre-written text can be created from within the computer program interface and used to compile said documents.

8. A method of claim 1 whereby a spreadsheet database containing all indicator fields, indicator field labels, and the plurality of unique varieties of pre-written blocks of text to which they correspond can be exported to a computer readable storage medium, edited using third-party software programs, and then imported back into the present invention and used to compile said text documents.

9. A method of claim 1 whereby a list of names, evaluation subject titles, and email addresses can be imported into the present invention from a spreadsheet database file and used to name, compile, select, switch between, and electronically transmit a plurality of said documents.

10. A computer program product system that compiles pre-written blocks of text into one cohesive document according to the user selection of indicator fields, described by indicator labels, which correspond to the aforementioned pre-written blocks of text.

11. A computer program product of claim 10 whereby a letter grade, number grade, or numerical value can be assigned and inserted into the said document according to the user selection of the indicator field that corresponds to the desired grade or value or by typing a user-defined grade or value into a text box and selecting the indicator field for that box.

12. A computer program product of claim 10 whereby said document can be printed and/or electronically transmitted to appropriate parties.

13. A computer program product of claim 10 whereby said document can be stored on or in a computer readable storage medium.

14. A computer program product of claim 10 whereby users can edit indicator field labels and their corresponding blocks of pre-written text from within the computer program interface.

15. A computer program product of claim 10 whereby entirely new indicator fields, indicator field labels, and their corresponding blocks of pre-written text can be created from within the computer program interface and used to compile said documents.

16. A computer program product of claim 10 whereby a spreadsheet database containing all indicator field labels and the plurality of unique varieties of pre-written blocks of text to which they correspond can be exported to a computer readable storage medium, edited using third-party software programs, and then imported back into the present invention and used to compile said documents.

17. A computer program product of claim 10 whereby a list of names, evaluation subject titles, and email addresses can be imported into the present invention from a spreadsheet database file and used to name, compile, select, switch between, and electronically transmit a plurality of said documents.
